(19) United States
(12) Patent Application Publication
(10) Pub. No.: US 2005/0254071 A1
(43) Pub. Date: Nov. 17, 2005

(54) Image rescaling method

(76) Inventor: Jun He, Taipei (TW)

Correspondence Address: HARNESS, DICKEY & PIERCE, P.L.C., P.O. BOX 8910, RESTON, VA, 20195, US

(21) Appl. No.: 10/844,331

(22) Filed: May 13, 2004

(51) Int. Cl. H04N 1/393; H04N 1/405; H04N 1/41; G06T 3/40

(52) U.S. Cl. 358/1.2; 358/3.07; 382/298; 358/426.04; 358/451

(57) ABSTRACT

A method of rescaling images first determines the rescaling rate from a source image to a destination image. Coordinates of pixels in the destination image are determined from the source image according to the rescaling rate. The source image is then scanned. Adjacent pixels with the same pixel value are combined into a pixel block. The intermediate format information of the pixel block is determined according to the coordinate of the pixel block in the destination image. Afterwards, the corresponding bitmap image is formed by halftone rendering according to the intermediate format information.

### BACKGROUND OF THE INVENTION

1. Field of Invention

The invention relates to an image processing method and, in particular, to a method of rescaling images.

2. Related Art

Bitmap images avoid the drawbacks of vector images. They can be used to generate pictures rich in colors that reproduce scenes in Nature. They can also be readily exchanged among different software programs. However, the bitmap images cannot be used to produce real 3D images. Moreover, the resealing and rotation of a bitmap image often result in distortion. In general, the sizes of such images are larger, thus having higher demands for memory and hard drive space. The principle of bitmap images is to have a set of data of each bitmap pixel. As the resoluation and number of colors increase, the disk space required by the image also becomes larger. Since an image becomes blurred and distorted during the process of magnification, a pixel in the source image will become a block in the destination image.

JPEG, GIF, and PNG documents are all compressed in order to reduce the sizes. However, compression only has limited effects. The bitmap images are still much larger than vector ones. In fact, when expanding the diameter of a bitmap image, the number of pixels becomes four times more.

A conventional method for magnifying bitmap images is to allocate a block or continuous memory from the system according to the size of the destination image. The block of continuous memory is used to store restored bitmap image information. Each pixel in the image is resized in proportion. After the smooth halftone process, the bitmap image information is generated and stored in the memory. This method is slow and occupies a large amount of system memory. Sometimes, one still needs to compress the data in order to save the memory. If the system has a lot of memory fragments or does not have sufficiently large memory, the method cannot be processed because the required large block of memory cannot be allocated.

### SUMMARY OF THE INVENTION

In view of the foregoing, the invention provides a method of rescaling images to reduce the system memory usage at the same time of increasing the image processing speed.

To achieve the above objective, the invention provides a method of resealing images. The method first determines the rescaling rate from a source image to a destination image. Coordinates of pixels in the destination image are determined from the source image according to the rescaling rate. The source image is then scanned. Adjacent pixels with the same pixel value are combined into a pixel block. The intermediate format information of the pixel block is determined according to the coordinate of the pixel block in the destination image. Afterwards, the pixels are used to form the corresponding halftone bitmap image.

The disclosed method uses the technology of pixel combination to increase the image processing speed. It further utilizes a storage technology to reduce the use of system memory, avoiding the requirement of large continuous memory. Therefore, when there are memory fragments in the system, the method can still process large images. The method can perform similar processes for different color spaces, generating the bitmap information of all color planes.

### BRIEF DESCRIPTION OF THE DRAWINGS

The invention will become more fully understood from the detailed description given hereinbelow illustration only, and thus are not limitative of the present invention, and wherein:

FIG. 1 is the overall flowchart of the disclosed method of rescaling images;

FIG. 2 is the flowchart of the disclosed determination image processing method;

FIG. 3 is a schematic view of the intermediate format information of the invention;

FIG. 4 is a flowchart of the disclosed symbolic command; and

FIG. 5 is a flowchart of the disclosed bitmap rendering.

### DETAILED DESCRIPTION OF THE INVENTION

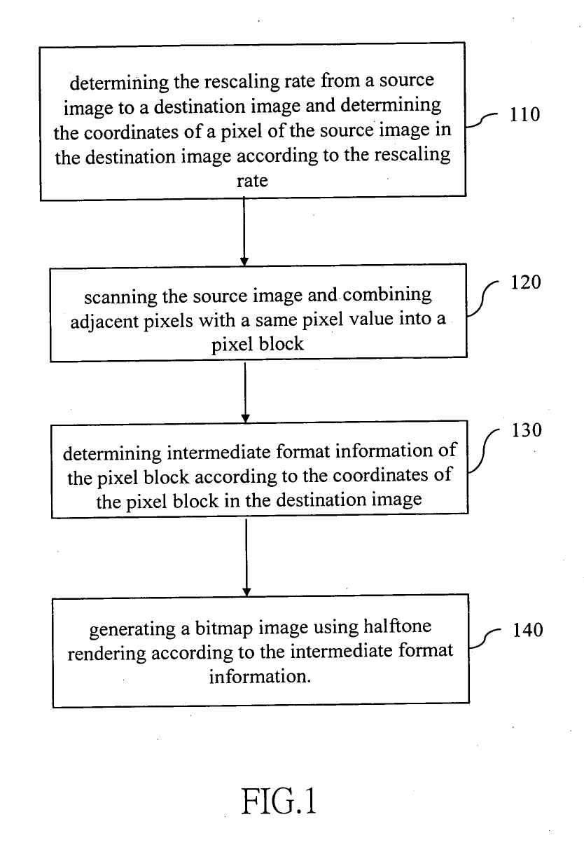

The specification discloses an image rescaling method. As shown in FIG. 1, the method first determines the resealing rate from a source image to a destination image. Coordinates of pixels in the destination image are determined from the source image according to the rescaling rate (step 110). The source image is then scanned. Adjacent pixels with the same pixel value are combined into a pixel block (step 120). The intermediate format information of the pixel block is determined according to the coordinate of the pixel block in the destination image (step 130). Afterwards, the pixels are used to form the corresponding halftone bitmap image (step 140).

The color spaces of an image to be processed can be RGB, CMYK, or Gray. The disclosed method can process different color planes in a similar way, generating the bitmap information of each color plane.

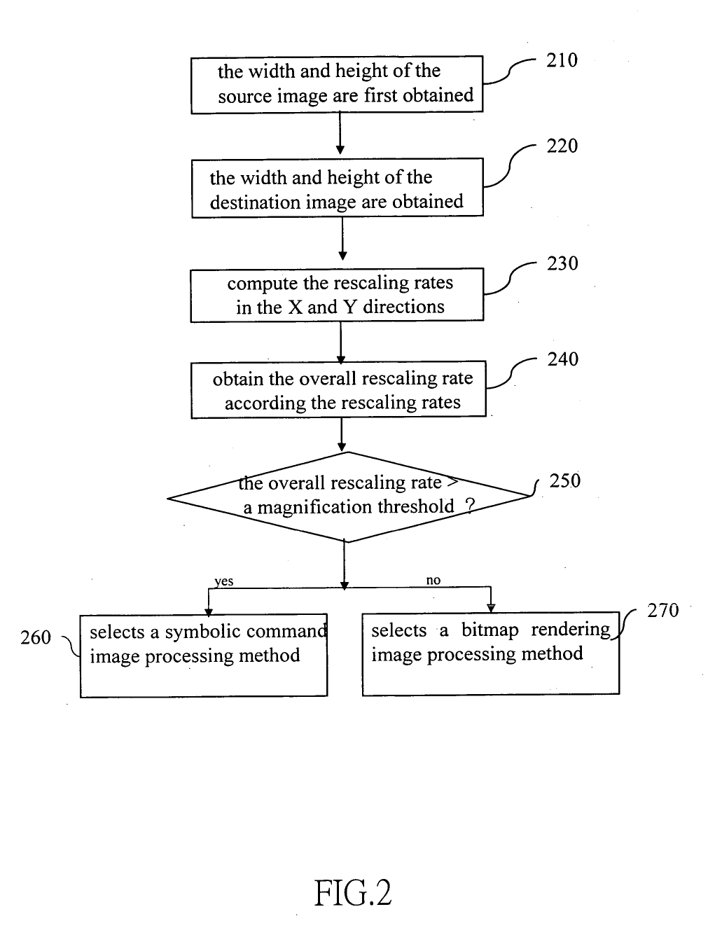

With reference to FIG. 2, the width and height of the source image are first obtained (step 210). Secondly, the width and height of the destination image are obtained (step 220). Then compute the rescaling rates in the X and Y directions, from which the coordinates of pixels in the destination region are computed (step 230). First, we set the coordinates of the upper left corner of the first pixel in the first row to be (X0, Y0). The steps in the X and Y directions in the destination system are ΔX and ΔY, respectively, according to the rescaling rates in both directions. Suppose the width and height of the source image are SrcWidth and SrcHeight, respectively; and the width and height of the destination image are DesWidth and DesHeight, respectively. The rescaling rates of the image in the X and Y directions are xScale and yScale, respectively, and the overall rescaling rate is ScaleRate. Thus, we have:
ΔX=xScale=DesWidth/SrcWidth
ΔY=yScale=DesHeight/SrcHeight
from which we obtain the overall rescaling rate ScaleRate=xScale*yScale (step 240).

The method then compares the overall rescaling rate and a magnification threshold (step 250). If the former is greater than the latter, the method selects a symbolic command image processing method (step 260); otherwise, a bitmap rendering image processing method is used (step 270).

In the following, we use an 8×8 gray-level planar image as an example to explain the invention. First, the method sets the magnification threshold. In the current embodiment, the magnification threshold is set to be 96. (The user can set the magnification threshold according to the size of the system memory.) The gray-level values of the 8×8 gray-level planar image is:

| | | | | | | | |
|---|---|---|---|---|---|---|---|
| 0x23 | 0x15 | 0x15 | 0x60 | 0x17 | 0x23 | 0x23 | 0x72 |
| 0x11 | 0x27 | 0x27 | 0x27 | 0x43 | 0x56 | 0x21 | 0x18 |
| 0xa3 | 0x89 | 0xb2 | 0x19 | 0x19 | 0x68 | 0xa7 | 0xa3 |
| 0x38 | 0x42 | 0x46 | 0xb3 | 0xa1 | 0xc5 | 0xd0 | 0x80 |
| 0x81 | 0x82 | 0xb6 | 0xb0 | 0x88 | 0x88 | 0x65 | 0x65 |
| 0x70 | 0x71 | 0x36 | 0x36 | 0xc8 | 0xa9 | 0xe1 | 0x70 |
| 0x61 | 0x80 | 0x20 | 0x25 | 0x49 | 0x50 | 0x51 | 0x55 |
| 0x73 | 0x73 | 0xb2 | 0xa1 | 0x85 | 0x85 | 0x85 | 0x85 |

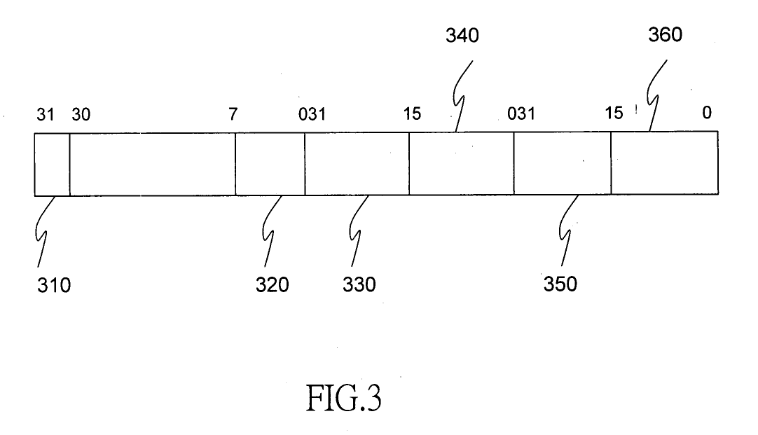

First, the overall magnification rate of the image is computed. The original 8×8 gray-level image is rescaled in the X and Y directions by the rates of 12 and 10. Therefore, the overall rescaling rate is 12*10=120. Comparing the overall magnification rate 120 and the magnification threshold 96, we see that the former is greater than the latter. Therefore, the symbolic command image processing method is used. The pixel block intermediate format information of the method is shown in FIG. 3. The command format is only 3 “longs,” totally 96 bits. The first long stores the information of “symbolic command 310 and pixel gray level 320.” The second long stores the information of “the X coordinate 330 and Y coordinate 340 of the upper left corner of the pixel.” The third long stores the information of “the X coordinate 350 and Y coordinate 360 of the lower right corner of the pixel.” If the conventional method is used, the 8×8 gray-level image is magnified by 120 times, requiring the memory of (8*12)*(8*10)/8=960 bytes. Using the symbolic command image processing method of the invention, when the gray levels of the pixels in each row are different, storing one pixel requires 3*32=96 bits. Since there are totally 8*8=64 pixels in the image, we need (64*96)/8=768 bytes of memory. When adjacent pixels have the same gray level in a row, we use 3 “longs” to record multiple pixel information . In this case, the required memory is less than 768 bytes. Magnifying the 8×8 gray-level image by 120 times, the symbolic command image processing method can save at least 192 bytes. The larger the image is, the more system memory the invention can save.

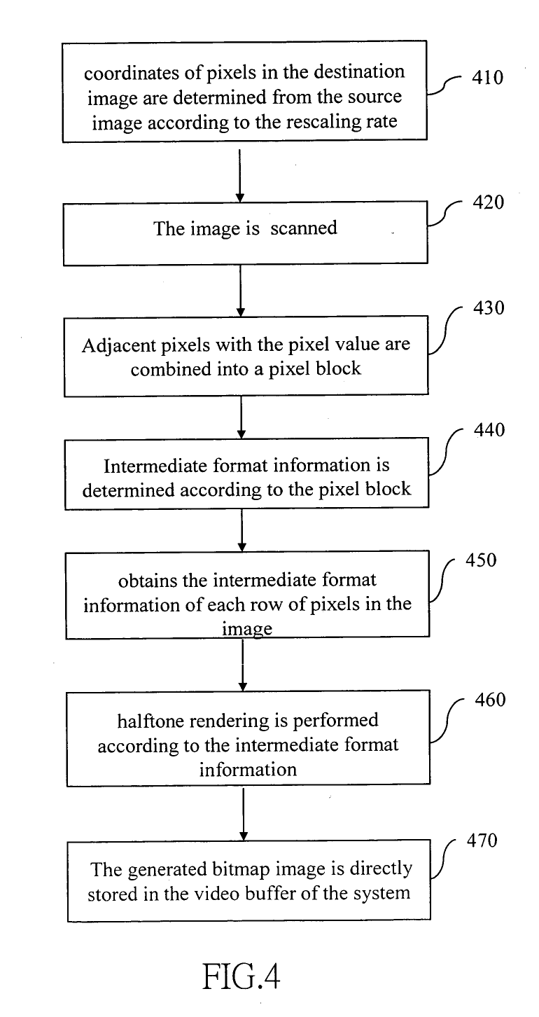

After deciding the image processing method, the image is processed accordingly. FIG. 4 shows the procedure of the disclosed symbolic command. First, coordinates of pixels in the destination image are determined from the source image according to the rescaling rate (step 410). The image is then scanned (step 420). Adjacent pixels with the pixel value are combined into a pixel block (step 430). When the values of adjacent pixels in a row are the same, they are combined into a pixel block and the processing region is expanded. Intermediate format information is determined according to the pixel block (step 440). The intermediate format information includes the symbolic command of the pixel block. In this embodiment, the symbolic command is set as 0×80000000, the coordinates of the upper left corner, and the coordinates of the lower right corner of the pixel block.

Suppose the value of the first pixel is 0×23, the X and Y coordinates of the upper left corner of the first pixel are (X0,Y0), and those of the lower right corner are (X0+ΔX, Y0+ΔY). The value of the second pixel is 0×15, different from the previous one. Therefore, the first symbolic command is:

| | | |
|---|---|---|
| 0x80000023 | (X0, Y0) | (X0 + ΔX, Y0 + ΔY) |

The X and Y coordinates of the upper left corner of the second pixel are (X0+ΔX,Y0), those of the lower right corner are (X0+ΔX+ΔX, Y0+ΔY)=(X0+2ΔX, Y0+ΔY). The scanned value of the third pixel is 0×15, same as the previous one. In this case, the X and Y coordinates of the upper left corner of the third pixel are (X0+ΔX+ΔX, Y0)=(XO0+2ΔX, Y0), and those of the lower right corner are (X0+ΔX+ΔX+ΔX, Y0+ΔY) =(X0+3ΔX, Y0+ΔY). The second and third pixels are thus combined into a “big pixel”. The scanned value of the fourth pixel is 0×60, different from its previous one. Therefore, the second symbolic command is

| | | |
|---|---|---|
| 0x80000015 | (X0 + ΔX, Y0) | (X0 + 3ΔX, Y0 + ΔY) |

The X and Y coordinates of the upper left corner of the fourth pixel are (X0+3ΔX,Y0) and those of the lower right corner are (X0+4ΔX, Y0+ΔY). The scanned value of the fifth pixel is 0×17, different from its previous one. The third symbolic command is then

| | | |
|---|---|---|
| 0x80000060 | (X0 + 3ΔX, Y0) | (X0 + 4ΔX, Y0 + ΔY) |

The X and Y coordinates of the upper left corner of the fifth pixel are (X0+4ΔX,Y0) and those of the lower right corner are (X0+5ΔX, Y0+ΔY). The scanned value of the fifth pixel is 0×23, different from its previous one. The fourth symbolic command is then

| | | |
|---|---|---|
| 0x800000017 | (X0 + 4ΔX, Y0) | (X0 + 5ΔX, Y0 + ΔY) |

The X and Y coordinates of the upper left corner of the sixth pixel are (X0+5ΔX,Y0) and those of the lower right corner are (X0+6ΔX, Y0+ΔY). The scanned value of the seventh pixel is 0×23, different from its previous one. The X and Y coordinates of the upper left corner of the seventh pixel are (X0+6ΔX,Y0) and those of the lower right corner are (X0+7ΔX, Y0+ΔY). The scanned value of the eighth pixel is 0×72, different from its previous one. The fifth symbolic command is then

| | | |
|---|---|---|
| 0x80000023 | (X0 + 5ΔX, Y0) | (X0 + 7ΔX, Y0 + ΔY) |

The X and Y coordinates of the upper left corner of the eighth pixel are (X0+7ΔX,Y0) and those of the lower right corner are (X0+8ΔX, Y0+ΔY). Since it is the last pixel of the row, we obtain the sixth symbolic command as

| | | |
|---|---|---|
| 0x800000072 | (X0 + 7ΔX, Y0) | (X0 + 8ΔX, Y0 + ΔY) |

After scanning the pixels in the second row, we obtain the corresponding six symbolic commands as

| | | |
|---|---|---|
| 0x80000011 | (X0, Y0 + ΔY) | (X0 + ΔX, Y0 + 2ΔY) |
| 0x80000027 | (X0 + ΔX, Y0 + ΔY) | (X0 + 4ΔX, Y0 + 2ΔY) |
| 0x80000043 | (X0 + 4ΔX, Y0 + ΔY) | (X0 + 5ΔX, Y0 + 2ΔY) |
| 0x80000056 | (X0 + 5ΔX, Y0 + ΔY) | (X0 + 6ΔX, Y0 + 2ΔY) |
| 0x80000021 | (X0 + 6ΔX, Y0 + ΔY) | (X0 + 7ΔX, Y0 + 2ΔY) |
| 0x800000018 | (X0 + 7ΔX, Y0 + ΔY) | (X0 + 8ΔX, Y0 + 2ΔY) |

Scanning the pixels in the 3^{rd}, 4^{th}, 5^{th}, 6^{th}, 7^{th}, and 8^{th} row of the image, there are totally 52 symbolic commands, occupying (52*96)/8=624 bytes of memory. This method saves 336 bytes (960−624) than directly generating the bitmap image.

When the system is required to generate a black-and-white bitmap image, it obtains the symbolic command information of each row of pixels in the image (step 450). For different pixels, halftone rendering is performed according to the intermediate format information (step 460). The generated bitmap image is directly stored in the video buffer of the system (step 470) in order to speed up the image processing and to effectively use the system memory.

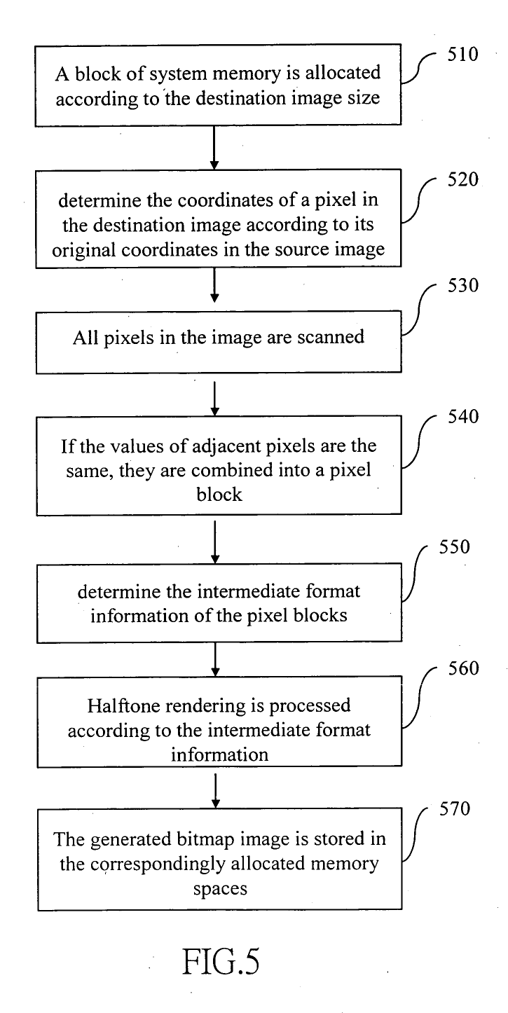

With reference to FIG. 5, when the source 8×8 gray-level image is magnified in the X and Y directions by the factor of 8, the overall magnification of the image is 8*8=64. Comparing the overall rescaling rate 64 and the magnification threshold 96, we see that the former is smaller than the latter. Therefore, the invention selects the bitmap rendering image processing method. This is because each pixel requires 64 bits of memory in this method, whereas the symbolic command image processing method requires 96 bits of memory. A block of system memory is allocated according to the destination image size (step 510). If the system has fragmented memory and cannot allocate a big block of memory, the invention uses the solution of storage by division. That is, the destination region is divided into two smaller regions and the corresponding memory spaces are applied. If the application is still not successful, the two smaller regions are further divided. This process is continued until the required bitmap memory spaces are obtained. For example, suppose the destination region has a size of 800 Kbytes. The method applies for 800 Kbytes of system memory in the first time. If it cannot be allocated, the 800 Kbytes destination region is divided into two blocks of 400 Kbytes for further applcations in the second time. If one memory block of 400 Kbytes is obtained whereas the other block memory of 400 Kbytes cannot be obtained, the unsuccessful block of 400 Kbytes is divided into two 200 Kbytes for the third application of two memory spaces of 200 Kbytes each. If both memory spaces of 200 Kbytes are successfully allocated, the memory allocation of the bitmap rendering is over. Otherwise, the above procedure is continued until the required memory spaces are obtained.

ΔX and ΔY are determined according to the rescaling rate of the image. They are used to determine the coordinates of a pixel in the destination image according to its original coordinates in the source image (step 520). All pixels in the image are scanned (step 530). When the values of adjacent pixels are the same, they are combined into a pixel block (step 540). The scan process is the same as the symbolic command method to determine the intermediate format information of the pixel blocks (step 550). Halftone rendering is processed according to the intermediate format information (step 560) to produce the destination bitmap. The generated bitmap image is stored in the correspondingly allocated memory spaces (step 570).

The only difference from the previous case is the processing means done to the scanned result. In one case, the invention generates the symbolic command of the image; whereas in the other case, the invention further performs halftone rendering to generate the destination bitmap image and to store it in the allocated memory spaces.

For the pixels in the first row, the bitmap rendering method is as follows:

For the region of (X0, Y0) to (X0+ΔX, Y0+ΔY), the halftone rendering of the pixel value of 0×23 is performed to generate a bitmap image that is to be stored in the corresponding memory space.

Combining the second and third pixels, the region of (X0+ΔX, Y0) to (X0+3ΔX, Y0+ΔY) is halftone rendered to have a pixel value of 0×15. The bitmap image is generated and stored in the corresponding memory space.

The region of (X0+3ΔX, Y0) to (X0+4ΔX, Y0+ΔY) is halftone rendered to have a pixel value of 0×60. The bitmap image is generated and stored in the corresponding memory space.

The region of (X0+4ΔX, Y0) to (X0+5ΔX, Y0+ΔY) is halftone rendered to have a pixel value of 0×17. The bitmap image is generated and stored in the corresponding memory space.

Combining the sixth and seventh pixels, the region of (X0+5ΔX, Y0) to (X0+7ΔX, Y0+ΔY) is halftone rendered to have a pixel value of 0×23. The bitmap image is generated and stored in the corresponding memory space.

The region of (X0+7ΔX, Y0) to (X0+8ΔX, Y0+ΔY) is halftone rendered to have a pixel value of 0×72. The bitmap image is generated and stored in the corresponding memory space.

For the pixels in the second row, the bitmap rendering method is as follows:

The region of (X0, Y0+ΔY) to (X0+ΔX, Y0+2ΔY) is halftone rendered to have a pixel value of 0×11. The bitmap image is generated and stored in the corresponding memory space.

Combining the second, third, and fourth pixels, the region of (X0+ΔX, Y0+ΔY) to (X0+4ΔX, Y0+2ΔY) is halftone rendered to have a pixel value of 0×27. The bitmap image is generated and stored in the corresponding memory space.

The region of (X0+4ΔX, Y0+ΔY) to (X0+5ΔX, Y0+2ΔY) is halftone rendered to have a pixel value of 0×43. The bitmap image is generated and stored in the corresponding memory space.

The region of (X0+5ΔX, Y0+ΔY) to (X0+6ΔX, Y0+2ΔY) is halftone rendered to have a pixel value of 0×56. The bitmap image is generated and stored in the corresponding memory space.

The region of (X0+6ΔX, Y0+ΔY) to (X0+7ΔX, Y0+2ΔY) is halftone rendered to have a pixel value of 0×21. The bitmap image is generated and stored in the corresponding memory space.

The region of (X0+7ΔX, Y0+ΔY) to (X0+8ΔX, Y0+2ΔY) is halftone rendered to have a pixel value of 0×18. The bitmap image is generated and stored in the corresponding memory space.

The same method is used to scan the 3^{rd}, 4^{th}, 5^{th}, 6^{th}, 7^{th}, and 8^{th} rows of pixels in the image. The same halftone rendering is processed to generate the bitmap images and to store them in the corresponding memory spaces.

Certain variations would be apparent to those skilled in the art, which variations are considered within the spirit and scope of the claimed invention.

1. A method of rescaling images comprising the steps of:
determining the rescaling rate from a source image to a destination image and determining the coordinates of a pixel of the source image in the destination image according to the rescaling rate;
scanning the source image and combining adjacent pixels with a same pixel value into a pixel block;
determining intermediate format information of the pixel block according to the coordinates of the pixel block in the destination image; and
generating a bitmap image using halftone rendering according to the intermediate format information.

2. The method of claim 1, wherein the intermediate format information includes a symbolic command of the pixel block, the coordinates of the upper left corner of the pixel block, and the coordinates of the lower right corner of the pixel block.

3. The method of claim 1 further comprising the step of comparing the rescaling rate with a rescaling threshold.

4. The method of claim 3, wherein the rescaling threshold is set according to the system memory configuration.

5. The method of claim 3, wherein all pixel blocks are simultaneously halftone-rendered into a bitmap image if the resealing rate is greater than the rescaling threshold.

6. The method of claim 5 further comprising the step of storing the bitmap image into a video buffer of the system.

7. The method of claim 3, wherein the pixel blocks are individually halftone-rendered into bitmap images if the resealing rate is smaller than the rescaling threshold.

8. The method of claim 7 further comprising the step of storing the generated bitmap images into system memory.

9. The method of claim 8, wherein the system memory is allocated according to the size of the destination image.
